(19) United States
(12) Patent Application Publication
(10) Pub. No.: US 2005/0088971 A1
(43) Pub. Date: Apr. 28, 2005

(54) ENHANCED LOCAL AAA REDIRECTOR

(75) Inventors: Liu Qing, Beijing (CN); Le Yanqun, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/761,583

(22) Filed: Jan. 22, 2004

(30) Foreign Application Priority Data
Oct. 27, 2003 (EP) 03024665.6

(51) Int. Cl. H04L 1/00

(52) U.S. Cl. 370/230

(57) ABSTRACT

A method, a system and network entities for processing service requests in a domain of a network comprising a plurality of domains, with the steps: analyzing an incoming service request in a service request input node in terms of destination information; determining, whether the destination information enables a direct forwarding of said service request to its destination; redirecting said service request, if said determining yields that said direct forwarding is not enabled; said redirecting comprising the steps: transmitting said received service request to an intermediate node; based on said received service request, performing a look-up in a database by said intermediate node for obtaining destination information required to enable a forwarding of said service request; sending said destination information from said intermediate node to said service request input node; and based on said sent destination information, forwarding said service request from said service request input node to its destination.

### FIELD OF THE INVENTION

The present invention relates to a method, a system, and network entities for processing service requests in a domain of a domain-based network. In particular, such a domain-based network consists of a plurality of domains and may be exemplified by the Internet or a Third Generation (3G) mobile communication network.

### BACKGROUND OF THE INVENTION

In recent years, communication technology has widely spread in terms of number of users and amount of use of the telecommunication services by the users. This also led to an increase in the number of different technologies and technological concepts nowadays in use. Additionally, the demands of users as well as the kind and number of services has significantly increased. There also exists a trend of merging different kinds of networks providing different services into each other in order to offer high comfort to the user and to integrate these services into each other. For example, charging a user for communication or used information services can be performed by a specialized service/network which is distinct from those services/network systems which are in charge of enabling the communication as such via the information network.

Many existing and future networks like the Internet are organized in a domain-based manner. This means that the whole network is constituted of a plurality of individual administrative areas, which are known as domains or realms. Each such domain covers a relatively small region, but by an inter-connection of many of such domains, the whole network can achieve an enormous coverage in terms of area and users. Additionally, each such domain itself can again be organized in a domain-based manner being constituted of so-called sub-domains. Such a network configuration represents a hierarchical structure and is advantageous for administration and operation of a large amount of users.

The individual domains are built up, organized and managed by a respective service provider, and they are organizationally confined and independent but inter-connected with each other.

A popular example for such a domain-based network is the Internet with the Internet service providers (ISP) providing individual inter-connected networks representing the domains. In this context, the term of a user's or user terminal's ‘home domain’ means the particular domain of the ISP with which a user or user terminal is registered. The well-known address format for Internet communications therefore is username@homedomain.

In a domain-based network arrangement as described above, each service provider basically provides for communication or information services for the users registered with him. Today, however, there exist many security relevant and/or user-related services which makes the provision of security aspects such as authentication and authorization mandatory in communication networks. Many future Internet services or mobile communication services will also require such functions. The rules and directives to be followed by users having access to databases, systems and resources can be summarized by the term “security policy”. If a user, for example, wants to use a security-relevant service of another service provider, the user has to authenticate and/or authorize himself. For this purpose, he needs a password, a security key or the like. Such information can be managed in a centralized way or by a specialized network or part of a network providing such user-related services.

Additionally, the aforementioned inter-connection of domains enables a user to utilize services of service providers different from his own service provider and also within domains different from his home domain. This feature is often referred to as roaming and makes an additional accounting functionality necessary, for example, in order to gather billing, auditing and reporting information about the “visiting” user.

Conventionally, a specialized network for performing such functions as described above is built up “on top of” the communication network, and is often referred to as AAA (authorization, authentication and accounting) network. The thus realized functions like system access and database look-ups can take place in specific and separate AAA nodes, but in practice, these nodes are often implemented within the nodes of the underlying communication network, which has the advantage of a joint use of hardware and thus reduced costs. Notwithstanding the hardware location, the AAA nodes offer a functionality which is distinct from other functionalities. Therefore, in the following specification a node is individually addressed as long as it provides a distinct functionality irrespective of its physical location or implementation.

For the sake of clarity and simplicity, it will hereinafter only be referred to AAA nodes. The structure of the AAA network is also in line with the underlying communication network like the Internet or a 3GPP network. More specifically, an AAA network servicing a domain-based communication network is also organized in a domain-based manner.

The use of AAA techniques provides as benefits an increased flexibility and control, scalability, and the usage of standardized authentication methods. However, specialized security and routing protocols are also needed for performing AAA functions properly and for routing respective messages related to AAA functions. Examples for such standardized AAA protocols, which are known to a skilled person, include RADIUS (Remote Access Dial-In User Services) which is standardized by the IETF (Internet Engineering Task Force), TACACS+ (Terminal Access Controller Access System) implemented by Cisco®, and Kerberos. These protocols are used for dial-in and terminal server access to the AAA network mainly from outside the domain. As an example, a user roaming in a domain of another service provider than his own provider has to authenticate himself within this domain. Therefore, he sends a request to an AAA node within his home domain for providing him with the required services like a password. Recently, the AAA Working Group of the Internet Engineering Task Force (IETF) is under way of standardizing a new RADIUS-based AAA protocol called Diameter.

The subsequent description focuses on the use of the Diameter protocol for these purposes of AAA. However, this serves as an example only and the principles underlying the present invention are also applicable to domain-based networks operating under another protocol as long as this other protocol is similar to the Diameter protocol and supports or is compatible to at least the routing functionality offered by Diameter.

The Diameter base protocol provides a session-oriented and policy-based framework for the functionality of Diameter routing of messages called (AAA) service requests. It is based on the nowadays commonly used challenge-response-type RADIUS protocol which is located at the network layer of the OSI network model. Diameter dial-up services are, for example, further on based on PPP (Point-to-Point Protocol) connections, but roaming support is enhanced, and the Mobile IP model is integrated, making Diameter the AAA protocol for the future. The terminology defined by the IETF in the version of the Internet draft which was found on their website at http://www.ietf.org/internet-drafts/draft-ietf-aaa-diameter-17.txt on Aug. 20, 2003 will form the basis for the terms used in the further specification.

Hitherto, when large amounts of users are administered by a service provider, i.e. within an individual domain, it is reasonable to deploy the AAA network in a hierarchical way. FIG. 1 shows such a hierarchical AAA deployment in a domain-based manner. In the following, the structure and operation of the system according to FIG. 1 will be described. In FIG. 1, the dashed lines represent bidirectional connections between entities being linked by these lines, and the dash-dotted lines indicate the administrative areas, i.e. the boundaries of the domains, operated by a respective service provider.

As can be seen in FIG. 1, a domain-based network generally comprises of a plurality of domains Dom_A, Dom_B, Dom_C, each of which is respectively administered by a separate service provider A, B, C. Although there are three such domains of three service providers shown in FIG. 1, such a network may comprise any number of domains. In between all domains, i.e. not belonging to an administrative sphere of one service provider, there can also exist network nodes. As an example, an AAA redirector R, the usage of which will be explained below, is depicted in FIG. 1.

Domains can be expected to have the same basic constitution. Hence, only domain A is described and a similar description of domains B, C is omitted.

Further, the hierarchical structure of an AAA network within a domain of service provider A is shown in detail in FIG. 1. The highest hierarchy layer consists of an entry node A1 of the domain Dom_A, e.g. an AAA proxy, which serves as an interface between this and other domains. This entry node is, therefore, connected to the AAA redirector R between all domains, to entry nodes B1, C1 of other domains, and to nodes of a lower hierarchy layer of Dom_A. In this second hierarchy layer, a plurality of service nodes A3a, A3b, A3c, e.g. AAA servers are located which provide the above-mentioned user-related services such as AAA services. As can be seen in FIG. 1, these service nodes are connected to each other. In a third hierarchy layer, a plurality of access nodes A3a1, A3a2; A3b1, A3b2; A3c1, A3c2 is connected to each respective service node A3a; A3b; A3c. A user can access the network via these access nodes (AR: access router).

It is to be noted that throughout the following description the term “user” shall always to be understood either as the user itself or as a user terminal by means of which the respective user connects to the network.

Each user registered with service provider A, i.e. in this domain Dom_A, is fixedly associated with one of the plurality of service nodes A3a, A3b, A3c, e.g. AAA server Beijing. The respective service node (also known as ‘home server’ of this user) manages method lists containing user and service information needed for the operation of the AAA functions related to this user. For example, policy information for authorization like passwords and security keys of a user for a special service is stored in these methods lists. A user being associated with AAA server Beijing A3a, for example, is assumed to access the network via an access node connected to this service node, e.g. AR Beijing1 A3a1 or AR Beijing2 A3a2.

The above structure also applies to AAA networks in other domains Dom_B, Dom_C, which is indicated by displaying the respective entry nodes (B1, C1).

AAA-related service requests intended for other domains exit the domain through the entry node A1 of the domain in which domain they are originated, and are transmitted to the AAA redirector R representing a domain-independent entity. In general, redirectors refer clients to servers and allow them to communicate directly. More specifically, redirectors obtain destination information for messages in order to enable a correct routing and forwarding of these messages. Since redirectors are generally not located in the forwarding path, they do not alter any information fields in the service request being handled. Service requests that are handled by an entry node B1 of a domain B and aim to a domain A (which is unknown to domain B) are rather forwarded to the redirector R for obtaining information about the destination domain A. The redirector finds out the address of the entry node A1 of the desired domain A. It then sends back the required information on how to reach the addressed domain A to the entry node B1. Then, entry node B1 is enabled to forward the service request to entry node A1.

AAA-related messages, i.e. AAA service requests, coming from outside the domain of service provider A are handled locally by the entry node A1. The incoming message usually contains the destination domain and the user name for whom AAA functions are requested. The handling of the service request thus comprises a look-up of the destination host (‘home server’) of this user, i.e. a service node A3a, A3b, A3c, in a user database, and a subsequent forwarding of the service request to the AAA server with which the respective user is associated.

FIG. 2 is an illustration showing the internal protocol structure of nodes of domain A according to FIG. 1. In detail, the entry node A1, two service nodes A3a, A3c and two access nodes A3a2, A3c1, one in connection with each service node, are shown as an example. It can be seen that the internal structure in terms of an implemented protocol stack, e.g. the protocol stack of the Diameter base protocol, of each of these nodes is comparable. In this regard, each of these nodes comprises a transport layer, a peer FSM layer, a session FSM layer, and an application layer of the respective security protocol (in this case, Diameter). Further, it can be seen that the physical connections between the nodes are established between the respective transport layers. Since a skilled person knows the functions of each layer, a detailed description thereof is omitted here.

FIG. 3 shows a home server (destination) determination procedure in response to an AAA service request according to the prior art. The illustration differs from the illustration of FIG. 2 in that the processing of an incoming service request is shown by the numbered arrow lines. The exemplary procedure refers to a user being associated with a service node with the address aaa.beijing.china.com, which user is roaming in another domain and has originated a service request from there.

The incoming service request (solid arrow line from the right edge) is (1) input to and processed by the peer FSM (finite state machine) layer of the local AAA proxy, i.e. the entry node A1. The service request is further transfers to the application layer of the entry node A1. The application layer handles a look-up (2), which is indicated by a dashed arrow line, in a user database DB_A for obtaining the required destination information. The result of this look-up is included into the service request, again processed (3) in the application layer and transferred to the peer FSM layer. The thus adapted service request is then, based on the information retrieved from the database and included (3) in the service request, forwarded (4) to the destination service node (home server) of the user under discussion. At the server, in this example aaa.beijing.china.com, the service request is finally processed in the peer FSM layer of service node A3a and transferred to the application layer for providing the required service, e.g. XXX. The access node, in this example beijing2.beijing.china.com A3a2, via which the user under discussion would access the network, if he was not located in a foreign domain, is not involved in this procedure.

However, the AAA deployment described above has some problems and drawbacks in practice.

First, the local handling of all incoming messages by the proxy, i.e. the performing of the database look-up and the processing through a multitude of protocol layers, is problematic. Every user being associated with a domain and currently roaming in a foreign domain has to send a service request back to his home domain, if he needs an AAA service. Especially, when large amounts of users are registered in service provider A's domain, it is likely that many users of this service provider are roaming in other domains at the same time (taking into consideration a high mobility of users). The entry node of domain A can then easily be loaded over burden due to many service requests being input in a short time interval. This can delay the required operation which is unacceptable under today's communication requirements.

Second, there occurs a problem, when several service nodes share the same domain name, e.g. china.com for service nodes aaa.beijing.china.com and aaa.hongkong.china.com, which is the case in the above-described example. Such a scenario is comparable to the above-mentioned sub-domains. In this case, users are not likely to specify their service nodes with which they are associated (home servers) when they roam under another service node within their home domain. Since the necessary redirect actions are, according to prior art, based on the domain name and user name only, this would lead to a problem in the processing of such intra-domain service requests.

### SUMMARY OF THE INVENTION

Consequently, it is an object of the present invention to remove the above drawbacks inherent to the prior art and to provide an improved system for processing service requests in a domain of a domain-based network. Also, it is an object of the present invention to provide a method for processing service requests in a domain of a domain-based network. Additionally, it is an object of the present invention to provide network devices capable of being used within the system of the present invention and of performing the method of the present invention.

According to a first aspect of the present invention, the above objects are achieved by a method for processing service requests in a domain of a network, wherein the network comprises a plurality of domains, wherein said service requests originate from a user terminal associated with a service node of said domain, and wherein at least one domain of said plurality of domains comprises at least a service request input node, an intermediate node, a database, an entry node, and a plurality of service nodes, and wherein said service request input node is connected to said intermediate node, to said entry node and to said service nodes, said intermediate node is further connected to said database and to said service nodes, and said service nodes are further connected to each other; said method comprising: analyzing an incoming service request in a service request input node in terms of destination information contained in a service request; determining in said service request input node, whether the destination information enables a direct forwarding of said service request to a destination; redirecting said service request by said service request input node, if said determining determines that said direct forwarding is not enabled; wherein said redirecting comprises: transmitting a received service request by said service request input node to an intermediate node; based on said received service request, performing a look-up in a database by said intermediate node for obtaining destination information required to enable a forwarding of said service request to said destination; sending said destination information from said intermediate node to said service request input node; and based on said sent destination information, forwarding said service request from said service request input node to said destination.

According to further advantageous aspects:
the method further comprises direct forwarding said service request by said service request input node to said destination, if said determining determines that said direct forwarding is enabled;
the step of analyzing comprises analyzing said incoming service request in said service request input node comprising an entry node of said domain, and wherein an entry node receives said service request from outside of said domain;
the step of analyzing comprises analyzing said incoming service request in said service request input node comprising a service node of a plurality of service nodes of said domain, with which a user terminal originating said service request is not associated, wherein said one of the plurality of service nodes receives said service request from within said domain;
the step of determining comprises determining in said service request input node that the received service request from within said domain is destined for a user terminal associated with said service node of said plurality of service nodes of said domain, and in response redirects said service request;
the step of determining comprises determining in said service request input node that the received service request from within said domain is destined for a user terminal not associated with said service node of said plurality of service nodes of said domain, and forwards said service request to said entry node of said domain for relaying said service request to another domain;
the step of analyzing comprises analyzing said incoming service request contained in said service requests comprising AAA service requests associated with authentication, authorization, and accounting functions;
the step of analyzing comprises processing said service requests based on a Diameter base protocol;
the step of analyzing comprises analyzing said incoming service request in said service request input node comprising said entry node of said domain comprising a proxy node;
the step of analyzing comprises analyzing said incoming service request in said service request input node comprising said entry node of said domain comprising a relay node;
the method further comprises providing a network including a plurality of domains, wherein the network comprises an Internet, and wherein the plurality of domains are established by respective service providers;
the further comprises providing a network including a plurality of domains, wherein the network comprises a Third Generation mobile communication network.

According to another aspect of the present invention, the above objects are achieved by a system for processing service requests in a domain of a network, wherein the network comprises a plurality of domains, wherein said service requests originate from a user terminal associated with a service node of said domain, and wherein at least one domain of said plurality of domains comprises at least a service request input node, an intermediate node, a database, an entry node, and a plurality of service nodes, and wherein said service request input node is connected to said intermediate node, to said entry node, and to said service nodes, said intermediate node is further connected to said database and to said service nodes, and said service nodes are further connected to each other; said system comprising: analyzing means in a service request input node for analyzing an incoming service request in terms of destination information contained in a service request; determining means in said service request input node for determining, whether the destination information enables a direct forwarding of said service request to a destination; redirecting control means in said service request input node for controlling a redirecting of said service request, if said determining means determines that said direct forwarding is not enabled; wherein said redirecting is performed by: transmitting means in said service request input node for transmitting a received service request from said service request input node to an intermediate node; look-up means in said intermediate node for performing, based on said service request received by receiving means, a look-up in a database for obtaining destination information required to enable a forwarding of said service request to said destination; sending means in said intermediate node for sending said destination information from said intermediate node to said service request input node; and forwarding means in said service request input node for forwarding said service request, based on said sent destination information, from said service request input node to said destination.

According to further advantageous aspects:
the system further comprises forwarding means in said service request input node for forwarding said service request to said destination, if said determining means determines that said direct forwarding is enabled;
the service request input node comprises an entry node of a domain, and wherein said entry node receives said service request from outside of said domain;
the service request input node comprises a service node of a plurality of service nodes of a domain, with which a user terminal originating said service request is not associated, wherein said one of the plurality of service nodes receives said service request from within said domain;
the service request input node comprises determining means for determining, whether the received service request from within said domain is destined for a user terminal associated with said service node of said plurality of service nodes of said domain, and redirecting means for redirecting said service request, if said service request is destined for a user terminal being associated with said service node of said plurality of said domain;
the service request input node comprises determining means for determining, whether the received service request from within said domain is destined for a user terminal not associated with said service node of said plurality of service nodes of said domain, and forwarding means for forwarding said service request to an entry node of said domain for relaying said service request to another domain, if said service request is destined for a user terminal being associated with said service node of said plurality of service nodes of said domain;
the service requests comprise AAA service requests associated with authentication, authorization, and accounting functions;
the service requests are processed based on a Diameter base protocol;
the entry node of said domain comprises a proxy node;
the entry node of said domain comprises a relay node;
a network including a plurality of domains comprises an Internet and the plurality of domains are established by respective service providers;
a network including a plurality of domains comprises a Third Generation mobile communication network.

According to another aspect of the present invention, the above objects are achieved by an intermediate node for redirecting service requests within a domain of a network, wherein the network comprises a plurality of domains, wherein said intermediate node is connected to an entry node, to a database, and to a plurality of service nodes of said domain; said intermediate node comprising: receiving means for receiving a service request from a service request input node; look-up means for performing, based on a received service request, a look-up in a database for obtaining destination information required for forwarding said service request to a destination; and sending means for sending said destination information from an intermediate node to said service request input node.

According to another aspect of the present invention, the above objects are achieved by a service node of a domain of a network, wherein the network comprises a plurality of domains, wherein said service node provides services for a user terminal associated with said service node, wherein said services are requested by service requests originating from said user terminal, wherein said service node is connected to an entry node of said domain, to an intermediate node of said domain which redirects service requests within said domain, and to service nodes of said domain.

According to another aspect of the present invention, the above objects are achieved by a service request input node within a domain of a network, wherein the network comprises of a plurality of domains, wherein said service request input node processes service requests originated from user terminals of said network, and wherein said service request input node is connected to an intermediate node of said domain which redirects service requests within a domain, and to a plurality of service nodes of said domain; said service request input node comprising: redirecting control means for controlling a redirecting of a received incoming service request; transmitting means for transmitting said received incoming service request to an intermediate node for obtaining destination information required for forwarding a service request to a destination; and forwarding means for forwarding said service request, based on said received destination information, from a service request input node to said destination.

According to further advantageous aspects:
the service request input node comprises an entry node of a domain, and receives service requests from outside of said domain;
the service request input node comprises a service node of a domain, and receives service requests from within said domain;
the service request input node further comprises determining means for determining, whether the received incoming service request from within said domain is destined for a user terminal associated with said service node of said domain, and redirects said service request, if said service request is destined for a user terminal associated with said service node of said domain;
the service request input node further comprises determining means for determining, whether the received incoming service request from within said domain is destined for a user terminal not associated with said service node of said domain, and forwarding means for forwarding said service request to an entry node of said domain for relaying said service request to another domain, if said service request is destined for a user terminal not associated with a service node of said domain.

Furthermore, advantageous aspects of the present invention include that said service requests comprise AAA service requests associated with authentication, authorization, and accounting functions, and that service requests are processed based on the Diameter base protocol.

Furthermore, advantageous aspects of the present invention include that the network consisting of a plurality of domains comprises an Internet and the domains are established by respective service providers, or that the network consisting of a plurality of domains comprises a 3G mobile communication network.

An advantage of the present invention is the provision of a mechanism to process incoming messages to a correct service node within the hierarchy of nodes of a domain of a network which consists of a plurality of domains. This can be performed with least spending of an entry node and with no modifications to the utilized protocol. In particular, the requirements on an entry node are alleviated in that it is possible to replace a proxy implementation by a relay implementation. This saves cost and implementation effort and can improve the robustness of the system.

It is a further advantage of the present invention that roaming within sub-domains, i.e. roaming under another service node within a home domain of a user, is easy to achieve. Even when new (e.g., Diameter) applications are adopted, no update to the entry node is needed.

Furthermore, it is an advantage of the present invention that the burden of an entry node when handling service requests can be reduced, a redirecting function within a domain is implemented, and such a solution can be deployed in the cascade way within a very large hierarchical framework.

Yet another advantage is that the use of a centralized roaming user management is possible.

### BRIEF DESCRIPTION OF THE DRAWINGS

In the following, the present invention will be described in greater detail with reference to the accompanying drawings, in which

FIG. 1 shows a hierarchical AAA deployment in a domain-based manner according to the prior art;

FIG. 2 is an illustration showing the internal protocol structure of nodes of a domain according to FIG. 1.

FIG. 3 shows a destination determination procedure in response to an AAA service request according to the prior art.

FIG. 4 shows a node deployment with a local redirector within a domain of a domain-based network according to the present invention.

FIGS. 5A to 5D show examples of routing tables of a redirector and an entry node, each according to the prior art and to the present invention.

FIG. 6 shows a destination determination procedure in response to a service request according to the present invention.

FIG. 7 shows a more detailed destination determination procedure according to FIG. 6 with contents of respective messages being exchanged during the procedure.

FIG. 8 shows a block diagram of an internal structure of network nodes according to the present invention.

### DETAILED DESCRIPTION OF AN EMBODIMENT OF THE PRESENT INVENTION

It is to be noted that the present invention will be described with a specific focus on the usage of an AAA network and the Diameter base protocol specified by the IETF AAA Working Group as the underlying AAA protocol. Nevertheless, the present invention is not limited to either of both but is also applicable to other types of domain-based networks (e.g. operation and management networks of mobile communication networks) providing user-related services and protocols therefor, e.g. RADIUS, as long as these other protocols are similar to the Diameter protocol and support or are compatible to at least to the routing functionality offered by Diameter.

Furthermore, the underlying domain-based communication network is herein exemplary described to be the Internet. However, any other domain-based communication network is conceivable, such as a 3G mobile communication system.

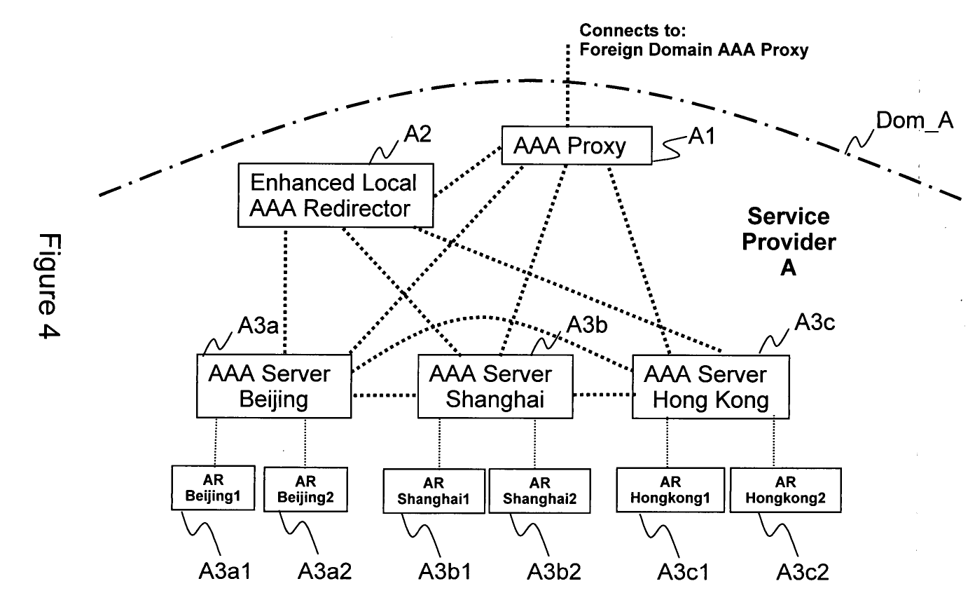

According to an embodiment of the present invention, FIG. 4 shows a node deployment with a local redirector within a domain of a domain-based network according to the present invention.

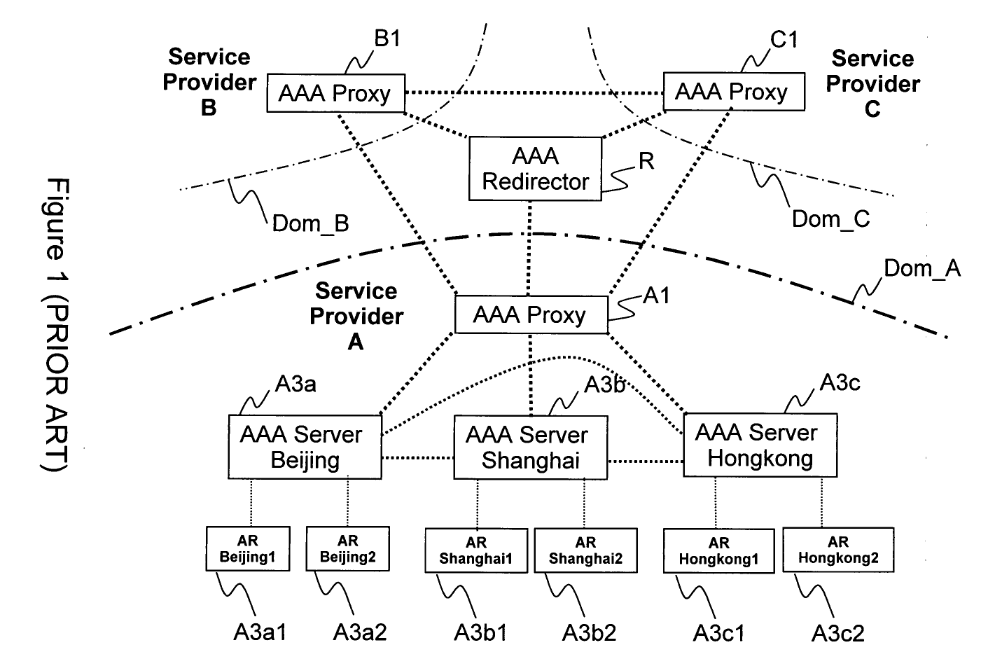

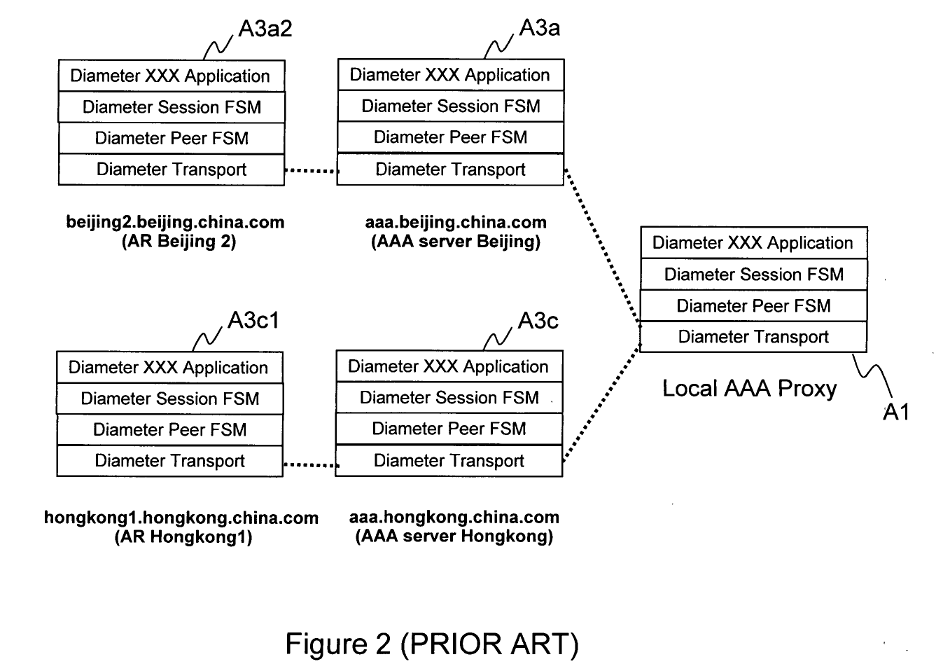

Basically, the illustration of FIG. 4 according to the present invention corresponds to the illustration of FIG. 1 according to the prior art. Namely, FIG. 4 only shows the domain Dom_A of service provider A. Consequently, entities with like reference signs than that of FIG. 1 represent comparable entities and their description will be omitted.

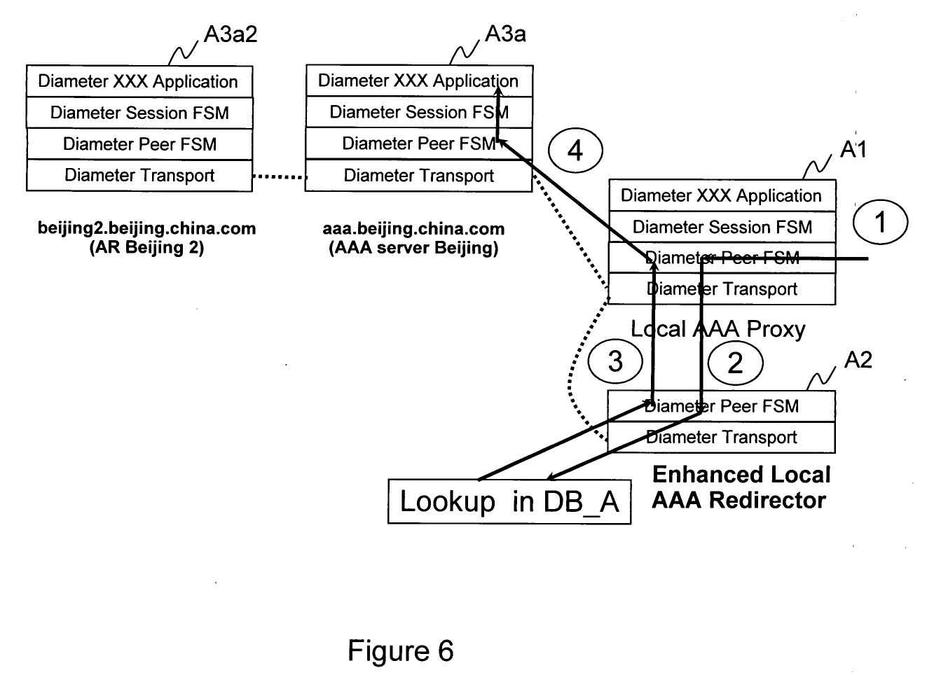

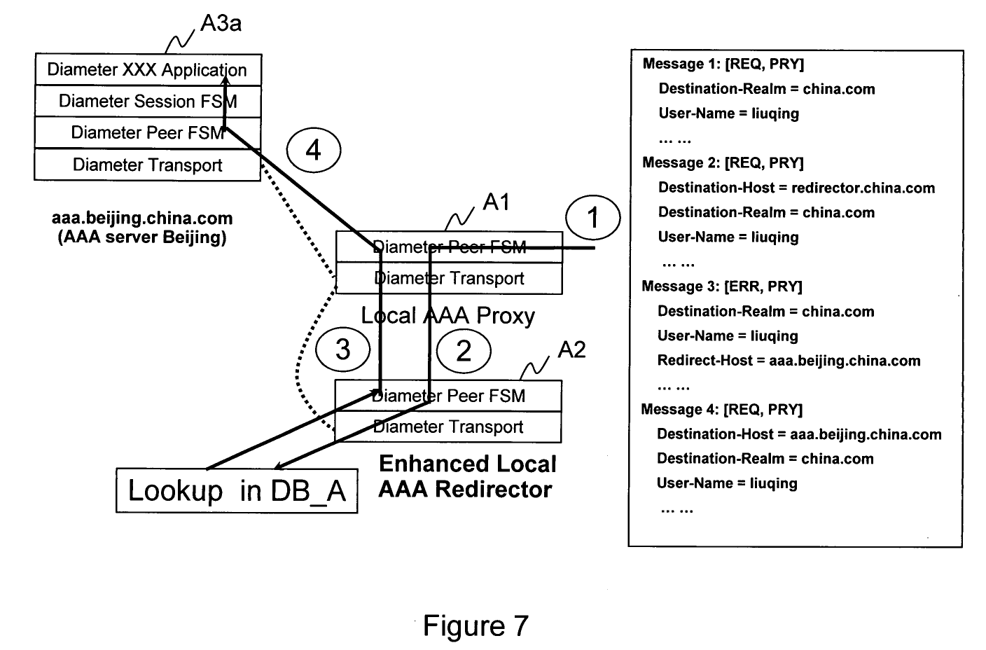

A so-called “enhanced local AAA redirector” is newly introduced into the network topology within this domain. This redirector denoted with A2 will hereinafter be referred to as an intermediate node since it is located in between the entry node A1 representing a first hierarchy layer and the service nodes A3a, A3b, A3c representing a second hierarchy layer. The intermediate node A2 is connected to the entry node, to a database (not shown) and to all service nodes A3a, A3b, A3c. It is adapted to provide and/or provides a redirecting function within domain Dom_A. A detailed description of such a local redirecting function will follow with reference to FIGS. 6 and 7.

It is to be noted that domain Dom_A serves as an example and that everything in this regard may also apply to any other domain of the network.

The present invention utilizes a routing function of an underlying AAA protocol, e.g. the Diameter base protocol routing function, to achieve efficient processing of (AAA) service requests. Further, the present invention utilizes the function of redirecting which is adapted to be and/or is available for processing of service requests within each domain of the domain-based network, irrespective of a redirecting function in-between different domains as is provided by redirector R according to the prior art.

In the present invention, the redirect procedure is adopted in such a way that unrecognized service requests, i.e. service requests in which the destination service node is not specified, are handled by the above-mentioned intermediate node A2. The intermediate node A2 then obtains the appropriate destination service node for the service request by performing a database look-up in a user database to find out the destination service node for the user originating the service request. It then sends back the respective information to the node from which it received the service request, and the service request will be forwarded by this node on the basis of its destination information. The redirect actions according to the present invention are based on the domain name and on the user name as known from the prior art. However, the redirect function according to the present invention is performed below the application layer of the protocol, e.g. the Diameter application layer. In the following, the such enhanced functionality will be explained in detail.

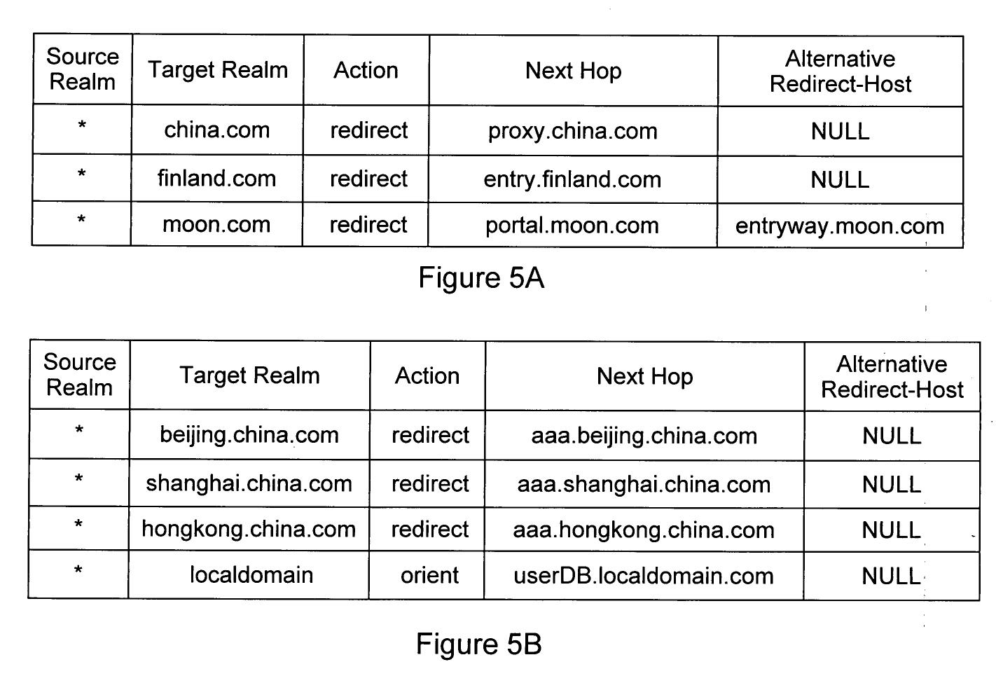

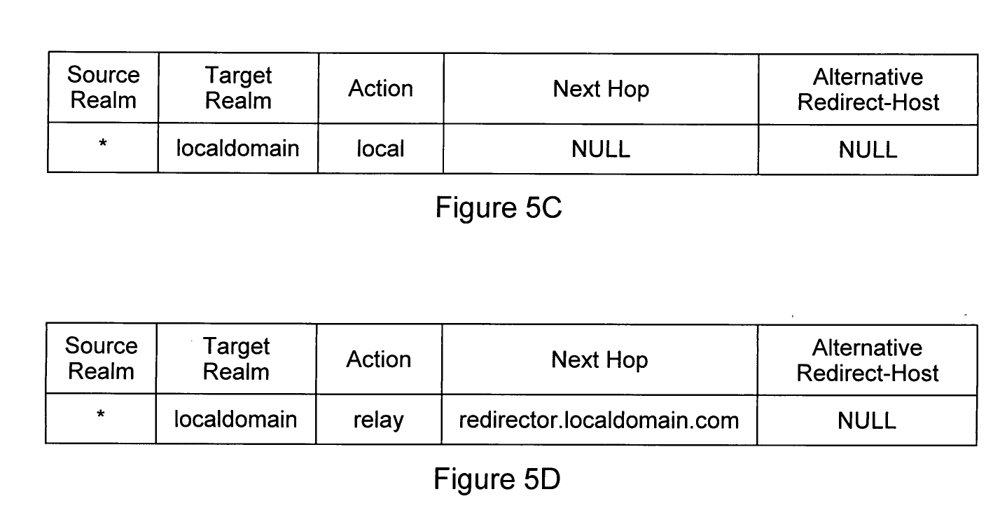

Therefore, FIGS. 5A to 5D show examples of routing tables of a redirector and an entry node, each according to the prior art and to the present invention.

A conventional domain-independent redirector redirects messages according to its domain-based routing table as the one shown in FIG. 5A, for example. It can be seen that the source domain (or source realm) does not have any influence on the routing procedure and can, hence, be arbitrary (*). A message with target domain (or target realm) finland.com, for example, will be handled according to the respective action, i.e. redirect. Thus, this message will be redirected to the node specified as next hop, i.e. the entry node of the respective domain finland.com, e.g. entry.finland.com. In case a domain has one or more further entry nodes than the one specified as next hop, these are specified as alternative redirect-hosts. If one entry node is not in operation or can not be reached due to a connection failure or the like, the message will be redirected to this alternative redirect-host, e.g. entryway.moon.com for domain moon.com.

In the perspective of the redirector with the above referenced routing table, all target domains are foreign domains since the redirector is located outside of all domains as described above with regard to the prior art deployment (see FIG. 1).

The enhanced local redirector according to the present invention is part of the domain of a service provider, and thus there also exists a localdomain from its perspective. If the target domain is localdomain, i.e. the home domain of the user originating the service request is equal to the home domain of the redirector, the message can not be redirected in a conventional way due to a lack of an appropriate action in the conventional routing table of FIG. 5A. Therefore, when adopting the present invention, the routing table of FIG. 5A is adapted in the way shown in FIG. 5B, i.e. an action “orient” is to be added for the case of target realm being localdomain.

Then, the message is “oriented” to a user database (not shown) of this domain, e.g. userDB.localdomain.com. This newly introduced “orient” action initiates the look-up in the user database server and the querying of the destination service node for the user being specified by the current service request.

A detailed description and explanation of the method of redirecting service requests will be given in the following by means of two examples.

### FIRST EXAMPLE

In a first example, the following problem is dealt with. When a user is roaming in a foreign domain, a service request will be sent back to the user's home domain, if the user requires a user-related (AAA) service. As, for example, the Diameter base protocol for AAA networks suggests, the request will according to the prior art be handled locally by the entry node. The corresponding routing table of such a conventional entry node is shown in FIG. 5C.

Yet, such local processing could easily cause the node being loaded over burden, if there are a lot of requests coming in at a time. In this regard, it is to be noted that the service request has also to be analyzed before its processing with respect to redirecting. Additionally, the domain entry node in a domain that has more than one service node would be puzzled since the incoming service request does not explicitly specify the destination host (destination service node). For being able to perform a redirect function, the node would have to modify the message after querying the database for the destination host. By doing so, the security measures adopted, e.g. by the Diameter application, would be violated because the entry node sits in the forwarding path and is therefore not allowed to modify incoming service requests. Thus, this solution is not feasible.

In this example, according to the invention, when the entry node receives a service request from a outside of its domain, it will not process it locally as known from the prior art. Rather, the service request lacking destination information will be transmitted to a local redirector of the localdomain for further instructions and/or information. Therefore, the domain-based routing table for the entry node is modified according FIG. 5D. Therein, a message for the localdomain will be relayed to a local redirector, e.g. redirector.localdomain.com, which performs the redirecting function according to the routing table of FIG. 5B.

FIG. 6 shows a destination determination procedure in response to a service request coming from outside a local domain according to the first example of the present invention.

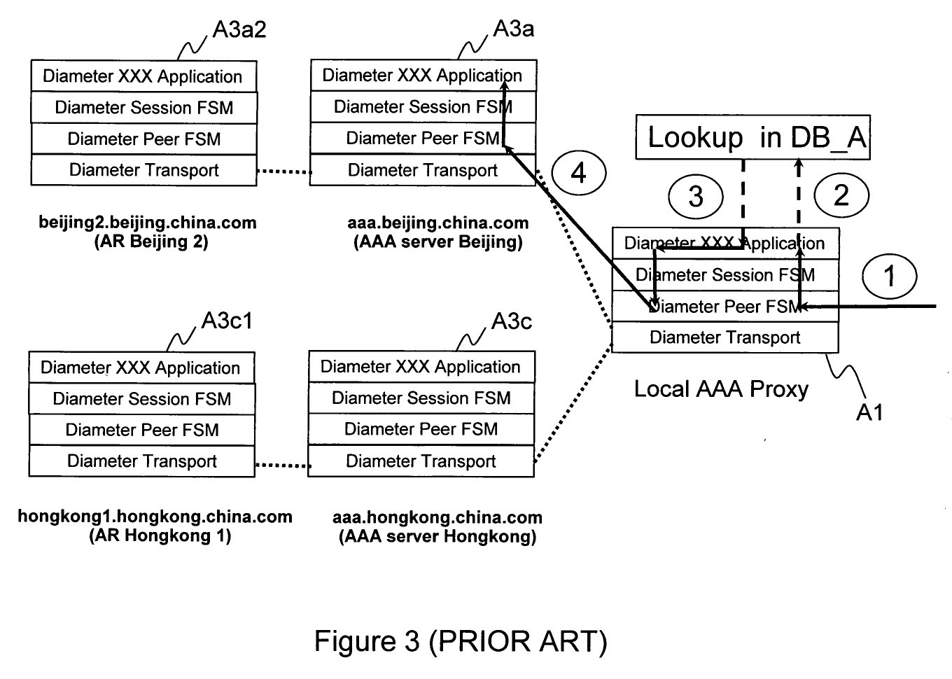

Basically, FIG. 6 corresponds to FIG. 3 in that these figures are based on the same scenario. However, the two nodes of FIG. 3 constituting the lower branch on the left side, i.e. service node A3c and access node A3c1, are omitted, and an intermediate node A2, i.e. an enhanced local AAA redirector, is newly introduced. It can be seen that the procedural steps (1) and (4) are comparable, but that procedural steps (2) and (3) clearly differ when comparing FIG. 3 according to the prior art and FIG. 6 according to the invention.

After receiving (1) of the service request in the peer FSM layer of the entry node A1, the service request is analyzed in terms of destination information contained in the service request. Upon this analyzing, it is determined, whether the destination information enables a direct forwarding of the service request to its destination. If said determining yields that said direct forwarding is enabled, the service request will be forwarded by the entry node directly to its destination, e.g. service node aaa.beijing.china.com. In this case, e.g. when the destination information contained in the service request enable a direct forwarding, a redirecting of the service request under discussion is not performed.

However, if said determining yields that said direct forwarding is not enabled, the service request will be redirected, and such redirecting is performed as follows. In the redirecting process, the service request is not transferred to the application layer of the entry node A1 to be processed locally, but it is processed according to the routing table of the entry node according to the present invention (see FIG. 5D). Accordingly, the service request is relayed to the local redirector, i.e. transmitted (2) to the peer FSM layer of the intermediate node A2. From thereon, a database look-up is performed according to the routing table of the local redirector according to the present invention (see FIG. 5B), i.e. the service request is oriented to the user database. The look-up is based on the received service request and is performed for obtaining destination information requires to enable a forwarding of this service request to its destination. The result of the look-up, i.e. the destination information for the respective service request, is received at the peer FSM layer of the intermediate node A2, and sent (3) from the intermediate node A2 to the peer FSM layer of the entry node A1. From there, the modified service request is, based on the sent destination information, forwarded (4) to its destination, namely service node aaa.beijing.china.com. The respective access node, namely beijing2.beijing.china.com, is again not involved in the processing of this service request.

In prior art, the entry node is often implemented by using a proxy node. According to the invention, the upper two layers of the protocol stack of the entry node are not involved any more for the processing of incoming messages as described above. This alleviates the requirements on the node. Thus, it is also possible to replace the proxy by a simple relay node and the policy processing can be handled in the local service node against the user's locale profile. This saves costs and implementation effort and can improve the robustness of the system.

In FIG. 7, the destination determination procedure according to FIG. 6 is shown with greater detail in that the contents of respective messages being exchanged during the procedure are shown. The left part of FIG. 7 differs from FIG. 6 only in that the two upper protocol layers of the entry node A1, i.e. the session FSM layer and the application layer, are not shown since these are not involved any more in connection with the present invention, and that the access node A3a2 is not shown. In the following, the procedure will be described again with regard to the messages being exchanged and their contents.

In this scenario, china.com is the localdomain under inspection, and the user liuqing being associated to the service node aaa.beijing.china.com originated a service request from a foreign domain to his/her home domain. This request (REQ) message (Message 1) being input to the entry node A1 of domain china.com contains the information that china.com is the destination domain and that liuqing is the concerned user name. The message is transmitted to the intermediate node A2 for further instruction because it does not specify the destination service node (destination host) for the user liuqing. This is also the case here since the present invention does not modify the underlying protocol. With the updated routing table of the entry node (see FIG. 5D), redirector.china.com is introduced into the service request (Message 2) as (temporary) destination host. The other information fields remain unchanged.

The intermediate node named redirector.china.com detects its local domain china.com as destination domain (see FIG. 5B) and, therefore, queries a database for the home service node (host) for the user liuqing by a look-up into the user database DB_A of the domain china.com. The intermediate node then replies the result of the look-up to the entry node A1 by sending an error (ERR) message (Message 3). This error message contains not only the destination domain and user name like above, but additionally contains an information in the redirect host field, namely aaa.beijing.china.com, i.e. the service node (for the user concerned) to which the service request is to be redirected. The service request is then updated with this new information, i.e. destination host is changed from its temporary assignment redirector.china.com into the actual destination service node of the user liuqing which is aaa.beijing.china.com. At this point, the entry node forwards the accordingly adapted service request (Message 4) to the destination service node (destination host) of the user under discussion, and the processing of the service request is completed as known from the art.

The exemplary messages of FIG. 7 correspond to message formats (e.g., REQ, ERR) known from the Diameter base protocol. The respective information is shown to be contained in predetermined information fields (e.g. destination-realm, user-name) within such messages, so-called attribute-value-pairs (AVP). However, other message formats and information fields being predetermined by other protocols can also be used when adapting the invention. Thus, the invention is not limited to the use of the Diameter base protocol.

### SECOND EXAMPLE

In a large domain, more than one service node prevails in this domain, and thus, different service nodes share the same domain name. In this example, a user being associated to a first service node, e.g. aaa.beijing.china.com A3a currently accesses the network via an access node, e.g. hongkong1.hongkong.china.com A3c1 which is connected to a second service node, e.g. aaa.hongkong.china.com A3c, whereby this second service node has the same domain name as the first one, namely china.com. Such a scenario is also known as intra-domain or sub-domain roaming. A service node receiving a service request from a user being associated with another service node of the same domain would then be puzzled since the service request of such a roaming user does not specify the destination service node (home server) of the user. And users are not likely to specify their home service node when they roam under another service node within their home domain. Such a service request would only contain the home domain and the user name. However, this would according to the prior art result in a processing of the service request in the entry node of the domain.

However, utilization of the entry node, which is deployed at the boundary of the administrative domain, is not preferable to handle roaming within sub-domains. Especially with a Diameter implementation, the routing decisions should be made within the Diameter base protocol and not by defining respective Diameter applications. It would therefore introduce too much implementation efforts if the entry node is used to handle many Diameter applications, which would be the case when handling of sub-domain roaming would take place in the entry node.

In this example, one of a plurality of service nodes of a respective domain, with which the user originating the service request is not associated receives the service request from within this domain. According to the present invention, when a service node receives such an “unrecognized” service request for the local domain, it transmits the request to an intermediate node according to the invention for providing a redirecting function. The redirector then detects localdomain to be the target domain and, thus, relays the request with the domain name and the user name to the user DB server as is already described in the first example. The following procedure is the same as described above.

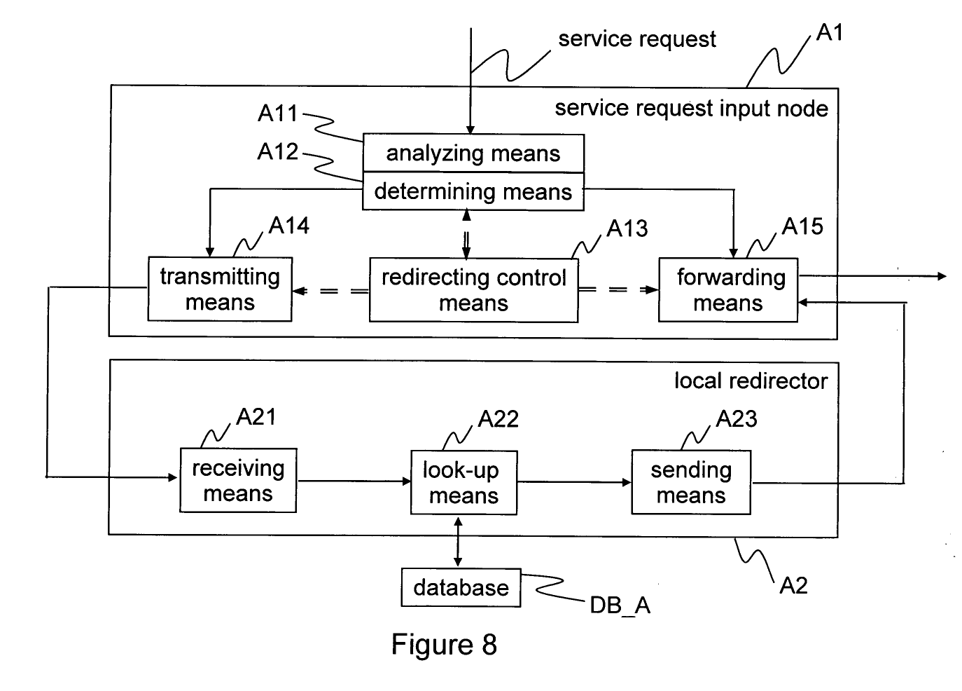

From this second example, it can be seen that a service request can be input to different nodes of a network, i.e. an entry node for service requests coming from outside the domain and a service node for service requests coming from within the domain, each being an example representing a “service request input node” within the framework of the present definitions of terminology adopted in the present specification. The basic internal structures of such a service request input node and an intermediate node according to the present invention are shown in the block diagram of FIG. 8.

In FIG. 8, a service request input node is exemplary shown as an entry node A1. Thereby, solid arrow lines represent the process of messages (i.e., service request and database inquiry message), whereas the dashed arrow lines represent control connections.

A service request input node, irrespective of whether it is an entry node or a service node, receives and processes an incoming service request and controls the local redirecting function. Thus, is comprises analyzing means A11, determining means A12, redirecting control means A13, transmitting means A14, and forwarding means A15. Thereby the analyzing means A11 analyze an incoming service request in terms of destination information contained therein, the determining means A12 determine, whether the destination information enables a direct forwarding of the service request to its destination, the redirecting control means A13 control a redirecting of a service request, if the determining means yield that said direct forwarding is not enabled, and the transmitting means A14 then transmit the received service request to an intermediate node A2. The forwarding means A15 either forward the service request directly to its destination, if the determining means yield that such direct forwarding is enabled, or forward based on the destination information sent by an intermediate node, the service request to its destination as part of a redirecting procedure.

Furthermore, an intermediate node according to the invention comprises receiving means A21 which receive a service request from a service request input node, look-up means A22 which perform, based on the service request, a look-up in a database DB_A for obtaining destination information required to enable a forwarding of the service request to its destination, and sending means A23 which send the destination information to the service request input node from which the service request was received.

According to the present invention a method, a system and network entities for processing service requests in a domain of a network comprising a plurality of domains are provided, which method comprises the steps: analyzing an incoming service request in a service request input node in terms of destination information; determining, whether the destination information enables a direct forwarding of said service request to its destination; redirecting said service request, if said determining yields that said direct forwarding is not enabled; said redirecting comprising the steps: transmitting said received service request to an intermediate node; based on said received service request, performing a look-up in a database by said intermediate node for obtaining destination information required to enable a forwarding of said service request; sending said destination information from said intermediate node to said service request input node; and based on said sent destination information, forwarding said service request from said service request input node to its destination.

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A method for processing service requests in a domain of a network, wherein the network comprises a plurality of domains, wherein said service requests originate from a user terminal associated with a service node of said domain, and wherein at least one domain of said plurality of domains comprises at least a service request input node, an intermediate node, a database, an entry node, and a plurality of service nodes, and wherein said service request input node is connected to said intermediate node, to said entry node and to said service nodes, said intermediate node is further connected to said database and to said service nodes, and said service nodes are further connected to each other; said method comprising:
analyzing an incoming service request in a service request input node in terms of destination information contained in a service request;
determining in said service request input node, whether the destination information enables a direct forwarding of said service request to a destination;
redirecting said service request by said service request input node, if said determining determines that said direct forwarding is not enabled; wherein said redirecting comprises
transmitting a received service request by said service request input node to an intermediate node;
based on said received service request, performing a look-up in a database by said intermediate node for obtaining destination information required to enable a forwarding of said service request to said destination;
sending said destination information from said intermediate node to said service request input node; and
based on said sent destination information, forwarding said service request from said service request input node to said destination.

2. A method according to claim 1, further comprising:
direct forwarding said service request by said service request input node to said destination, if said determining determines that said direct forwarding is enabled.

3. A method according to claim 1, wherein said step of analyzing comprises analyzing said incoming service request in said service request input node comprising an entry node of said domain, and wherein an entry node receives said service request from outside of said domain.

4. A method according to claim 1, wherein said step of analyzing comprises analyzing said incoming service request in said service request input node comprising a service node of a plurality of service nodes of said domain, with which a user terminal originating said service request is not associated, wherein said one of the plurality of service nodes receives said service request from within said domain.

5. A method according to claim 4, wherein said step of determining comprises determining in said service request input node that the received service request from within said domain is destined for a user terminal associated with said service node of said plurality of service nodes of said domain, and in response redirects said service request.

6. A method according to claim 4, wherein said step of determining comprises determining in said service request input node that the received service request from within said domain is destined for a user terminal not associated with said service node of said plurality of service nodes of said domain, and forwards said service request to said entry node of said domain for relaying said service request to another domain.

7. A method according to claim 1, wherein said step of analyzing comprises analyzing said incoming service request contained in said service requests comprising AAA service requests associated with authentication, authorization, and accounting functions.

8. A method according to claim 7, wherein said step of analyzing comprises processing said service requests based on a Diameter base protocol.

9. A method according to claim 3, wherein said step of analyzing comprises analyzing said incoming service request in said service request input node comprising said entry node of said domain comprising a proxy node.

10. A method according to claim 3, wherein said step of analyzing comprises analyzing said incoming service request in said service request input node comprising said entry node of said domain comprising a relay node.

11. A method according to claim 1, further comprising:
providing a network including a plurality of domains, wherein the network comprises an Internet, and wherein the plurality of domains are established by respective service providers.

12. A method according to claim 1, further comprising:
providing a network including a plurality of domains, wherein the network comprises a Third Generation mobile communication network.

13. A system for processing service requests in a domain of a network, wherein the network comprises a plurality of domains, wherein said service requests originate from a user terminal associated with a service node of said domain, and wherein at least one domain of said plurality of domains comprises at least a service request input node, an intermediate node, a database, an entry node, and a plurality of service nodes, and wherein said service request input node is connected to said intermediate node, to said entry node, and to said service nodes, said intermediate node is further connected to said database and to said service nodes, and said service nodes are further connected to each other; said system comprising:
analyzing means in a service request input node for analyzing an incoming service request in terms of destination information contained in a service request;
determining means in said service request input node for determining, whether the destination information enables a direct forwarding of said service request to a destination;
redirecting control means in said service request input node for controlling a redirecting of said service request, if said determining means determines that said direct forwarding is not enabled; wherein said redirecting is performed by
transmitting means in said service request input node for transmitting a received service request from said service request input node to an intermediate node;
look-up means in said intermediate node for performing, based on said service request received by receiving means, a look-up in a database for obtaining destination information required to enable a forwarding of said service request to said destination;
sending means in said intermediate node for sending said destination information from said intermediate node to said service request input node; and
forwarding means in said service request input node for forwarding said service request, based on said sent destination information, from said service request input node to said destination.

14. A system according to claim 13, further comprising:
forwarding means in said service request input node for forwarding said service request to said destination, if said determining means determines that said direct forwarding is enabled.

15. A system according to claim 13, wherein said service request input node comprises an entry node of a domain, and wherein said entry node receives said service request from outside of said domain.

16. A system according to claim 13, wherein said service request input node comprises a service node of a plurality of service nodes of a domain, with which a user terminal originating said service request is not associated, wherein said one of the plurality of service nodes receives said service request from within said domain.

17. A system according to claim 16, wherein said service request input node comprises determining means for determining, whether the received service request from within said domain is destined for a user terminal associated with said service node of said plurality of service nodes of said domain, and redirecting means for redirecting said service request, if said service request is destined for a user terminal being associated with said service node of said plurality of said domain.

18. A system according to claim 16, wherein said service request input node comprises determining means for determining, whether the received service request from within said domain is destined for a user terminal not associated with said service node of said plurality of service nodes of said domain, and forwarding means for forwarding said service request to an entry node of said domain for relaying said service request to another domain, if said service request is destined for a user terminal being associated with said service node of said plurality of service nodes of said domain.

19. A system according to claim 13, wherein said service requests comprise AAA service requests associated with authentication, authorization, and accounting functions.

20. A system according to claim 19, wherein service requests are processed based on a Diameter base protocol.

21. A system according to claim 15, wherein said entry node of said domain comprises a proxy node.

22. A system according to claim 15, wherein said entry node of said domain comprises a relay node.

23. A system according to claim 13, a network including a plurality of domains comprises an Internet and the plurality of domains are established by respective service providers.

24. A system according to claim 13, further comprising: a network including a plurality of domains comprises a Third Generation mobile communication network.

25. An intermediate node for redirecting service requests within a domain of a network, wherein the network comprises a plurality of domains, wherein said intermediate node is connected to an entry node, to a database, and to a plurality of service nodes of said domain; said intermediate node comprising:
receiving means for receiving a service request from a service request input node;
look-up means for performing, based on a received service request, a look-up in a database for obtaining destination information required for forwarding said service request to a destination; and
sending means for sending said destination information from an intermediate node to said service request input node.

26. An intermediate node according to claim 25, wherein said service requests comprise AAA service requests associated with authentication, authorization, and accounting functions.

27. A service node of a domain of a network, wherein the network comprises a plurality of domains, wherein said service node provides services for a user terminal associated with said service node, wherein said services are requested by service requests originating from said user terminal, wherein said service node is connected to an entry node of said domain, to an intermediate node of said domain which redirects service requests within said domain, and to service nodes of said domain.

28. A service node according to claim 27, wherein said service requests comprise AAA service requests associated with authentication, authorization, and accounting purposes functions.

29. A service request input node within a domain of a network, wherein the network comprises of a plurality of domains, wherein said service request input node processes service requests originated from user terminals of said network, and wherein said service request input node is connected to an intermediate node of said domain which redirects service requests within a domain, and to a plurality of service nodes of said domain; said service request input node comprising:
redirecting control means for controlling a redirecting of a received incoming service request;
transmitting means for transmitting said received incoming service request to an intermediate node for obtaining destination information required for forwarding a service request to a destination; and
forwarding means for forwarding said service request, based on said received destination information, from a service request input node to said destination.

30. A service request input node according to claim 29, wherein said service request input node comprises an entry node of a domain, and receives service requests from outside of said domain.

31. A service request input node according to claim 29, wherein said service request input node comprises a service node of a domain, and receives service requests from within said domain.

32. A service request input node according to claim 31, further comprising:
determining means for determining, whether the received incoming service request from within said domain is destined for a user terminal associated with said service node of said domain, and redirects said service request, if said service request is destined for a user terminal associated with said service node of said domain.

33. A service request input node according to claim 31, further comprising:
determining means for determining, whether the received incoming service request from within said domain is destined for a user terminal not associated with said service node of said domain, and forwarding means for forwarding said service request to an entry node of said domain for relaying said service request to another domain, if said service request is destined for a user terminal not associated with a service node of said domain.

34. A service request input node according to claim 29, wherein said service requests comprise AAA service requests associated with authentication, authorization, and accounting functions.
